(19) United States
(12) Patent Application Publication
(10) Pub. No.: US 2019/0321256 A1
(43) Pub. Date: Oct. 24, 2019

(54) AUTOMATIC CHEST COMPRESSION APPARATUS

(71) Applicant: Daniel Shawn Krewson, Camano Island, WA (US)

(72) Inventor: Daniel Shawn Krewson, Camano Island, WA (US)

(21) Appl. No.: 16/391,594

(22) Filed: Apr. 23, 2019

Related U.S. Application Data
(60) Provisional application No. 62/661,276, filed on Apr. 23, 2018.

(51) Int. Cl. A61H 31/00

(52) U.S. Cl. CPC A61H 31/006; A61H 2201/1207; A61H 2201/1657; A61H 2201/0157; A61H 2201/1463; A61H 2201/1619; A61H 2230/065; A61H 2201/0192; A61H 2201/0153; A61H 2201/0119

(57) ABSTRACT

A portable as well as fixed but adjustable automated compression device that applies chest compressions to aid in moving blood to oxygenate the brain and heart and, in some cases, restarting the heart, the lungs, or both, the mechanical chest compression device including a compressor head, a prime mover to drive the compressor head in a reciprocating or oscillating motion, a handle for manual operation, and actuator control to render it hand-holdable and selectively controllable. A stand can be used to support the compression device for hands-free operation.

### BACKGROUND

### Technical Field

The present disclosure pertains to the mechanical application of cardio-pulmonary resuscitation (CPR) techniques and, more particularly, to portable as well as fixed but adjustable automated compression devices that apply chest compressions to aid in moving blood to oxygenate the brain and heart and, in some cases, restarting the heart.

### Description of the Related Art

Full or partial cardiac arrest in both humans and animals results in cessation of or reduced blood flow to the body, including the brain, lungs, and the heart itself. The manual compression of the heart has been proven to aid in maintaining blood flow, even if minimal, in order to reduce or eliminate tissue damage when the heart fails.

The most common technique to restart the heart or at a minimum to maintain partial blood flow is to apply manual periodic compressions to the chest in the vicinity of the heart, which if done correctly will move blood through the heart and other parts of the body. In addition, when there is respiratory arrest, air can be forced into the lungs through rescue breathing, i.e., where the responder applies mouth-to-mouth resuscitation. The combination of manual chest compressions and mouth-to-mouth resuscitation has come to be known as Cardiopulmonary Resuscitation or CPR.

One difficulty in using CPR is the amount of effort that is required to maintain an adequate number of chest compressions while periodically applying mouth-to-mouth resuscitation. Studies have shown that for the untrained, it may be just as effective to just apply the chest compressions until medical personnel arrive. However, even doing chest compressions alone can be ineffective if not done with sufficient force, which can itself be fatiguing. Hence, there is a need for a device that can apply chest compressions with minimal or no effort on the part of a responder.

### BRIEF SUMMARY

The present disclosure is directed to an automated chest compression apparatus that can take three forms—a hand-held device, a rail-mounted system, and a floor-mounted system. Ideally the compression device is powered by electricity, although it may be powered pneumatically or hydraulically.

In accordance with one aspect of the present disclosure, a mechanical chest compression device is provided that includes a compressor head and a prime mover to drive the compressor head in a reciprocating or oscillating motion. Ideally, the device includes a handle and actuator control to render it hand-holdable and selectively controllable.

In accordance with another aspect of the present disclosure, a mechanical chest compression system is provided that includes a chest compression device and a stand to support the device on the floor, ground, or other supporting structure. The device includes a reciprocating compressor, a compression head with chest pad, and a prime mover to drive the reciprocating compressor. A back plate can be provided that attaches to the device and opposes the force exerted by the device, which can be used when the stand is not fixedly attached to the floor, ground, or other structure.

In accordance with still yet another aspect of the present disclosure, a mechanical chest compression system is provided that includes a chest compression device and a rail mount that attaches to a rail to enable selective positioning of the chest compression device. An articulating arm can be provided to enable a greater range of movement and more precise positioning of the compression device. The device includes a reciprocating compressor, a compression head with chest pad, and a prime mover to drive the reciprocating compressor.

In accordance with another aspect of the present disclosure, the device and system include a sensor to detect the presence of a heartbeat and can automatically shut off the chest compression device in response to the detection of the heartbeat.

In accordance with another aspect of the present disclosure, the compression head includes two ends, one sized for an adult human and the other sized for an adult infant or child (juvenile).

In accordance with still yet another aspect of the present disclosure, the chest compression device is adjustable in either the amount of force or pressure or in the depth of compression or both.

In accordance with a further aspect of the present disclosure, a portable, hand-holdable mechanical compression system for use in resuscitation is provided. The system includes a compression apparatus having a housing, a prime mover, and a compression head operatively coupled to the prime mover and configured for oscillatory movement in response to activation of the prime mover, the compression head having a compression pad sized and shaped to bear against skin, and a stand having a mounting apparatus and removably coupleable to the compression apparatus to support the compression apparatus for hands-free operation.

In accordance with another aspect of the foregoing implementation, the compression apparatus includes a handle for manual operation.

In accordance with a further aspect of the foregoing implementation, the compression apparatus is adjustable for one or more or all of a speed of oscillatory movement, a length of stroke of the compression head, and a pressure applied by the compression head during oscillatory movement of the compression head.

In accordance with another aspect of the present disclosure, the system includes a sensor coupled to the prime mover and configured to control activation and deactivation of the prime mover in response to the sensor sensing a heartbeat.

As will be readily appreciated from the foregoing summary, the device and system achieve a more reliable, robust, and controllable administration of chest compressions while providing versatility and convenience. It can be used in vehicles, attached to a stretcher, and temporarily or permanently attached to the floor. When mounted, the system frees the responder's hands to perform other tasks, such as carrying a stretcher, treating wounds, etc.

### BRIEF DESCRIPTION OF THE SEVERAL VIEWS OF THE DRAWINGS

The foregoing and other features and advantages of the present disclosure will be more readily appreciated as the same become better understood from the following detailed description when taken in conjunction with the accompanying drawings, wherein:

FIG. 1 is an isometric view of a portable, hand-holdable chest compression device formed in accordance with the present disclosure;

FIG. 2 is a side elevational view of the portable, hand-holdable chest compression device of FIG. 1 in use on a human being;

FIG. 3 is an isometric view of an automated mechanical chest compression system formed in accordance with the present disclosure employing the chest compression device of FIG. 1 and held in place with a stand; and

FIG. 4 is an isometric view of an automated mechanical chest compression system formed in accordance with the present disclosure employing the chest compression device of FIG. 1 and held in place on a rail.

### DETAILED DESCRIPTION

In the following description, certain specific details are set forth in order to provide a thorough understanding of various disclosed implementations. However, one skilled in the relevant art will recognize that implementations may be practiced without one or more of these specific details, or with other methods, components, materials, etc. In other instances, well-known structures or components or both associated with the use of reciprocating mechanical devices, such as electric motors, wiring, switches, and the like as well as anatomical features of the heart, chest, and the circulatory system of humans and animals have not been shown or described in order to avoid unnecessarily obscuring descriptions of the various implementations of the present disclosure.

Unless the context requires otherwise, throughout the specification and claims that follow, the word “comprise” and variations thereof, such as “comprises” and “comprising,” are to be construed in an open inclusive sense, that is, as “including, but not limited to.” The foregoing applies equally to the words “including” and “having.”

The present disclosure will be described in connection with several representative implementations in the context of treating a person. It is to be understood that the present disclosure will have application to any animal having either a heart or lungs or both a heart and lungs. Hence, a “person” for purposes of this disclosure is intended to embrace the foregoing, including without limitation mammals and other animals, including adults, juveniles, and infants.

Reference throughout this description to “one implementation” or “an implementation” means that a particular feature, structure, or characteristic described in connection with the implementation is included in at least one implementation. Thus, the appearance of the phrases “in one implementation” or “in an implementation” in various places throughout the specification are not necessarily all referring to the same implementation. Furthermore, the particular features, structures, or characteristics may be combined in any suitable manner in one or more implementations.

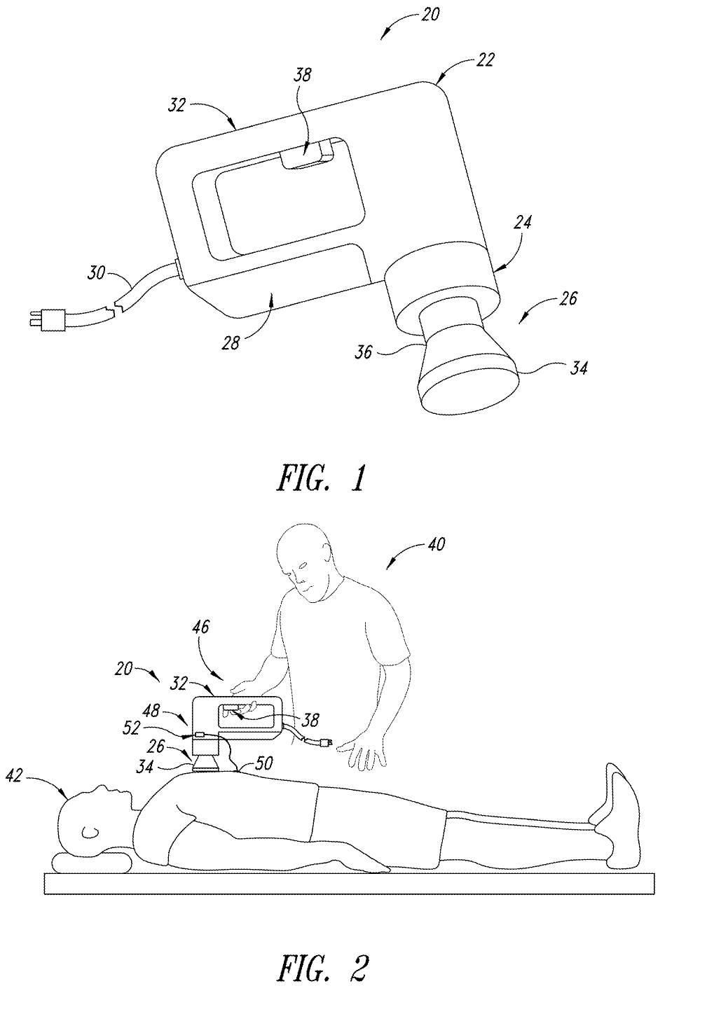

Referring initially to FIGS. 1 and 2, shown therein is a portable chest compression device 20 that is designed to be hand holdable. The device 20 includes a body 22 that houses a motorized compressor 24 coupled to a removable compression head 26. The compressor 24 is readily commercially available and will not be described in detail herein. Briefly, the compressor 24 can be pneumatic, hydraulic, or, as shown herein, electric. The electric version can be powered by a removable and rechargeable battery 28 or via 110 Volt house current via a standard plug 30 or both. If the device 20 is powered by pneumatics or hydraulics, the plug and battery would be replaced by a suitable hydraulic or pneumatic hose and reservoir as is known in the art.

The device 20 includes a handle 32 that can be grasped with one hand, which enables a responder to have one hand free. Alternatively, the handle 32 is sized large enough to accommodate two adult human hands to enable an individual who may be weak or lightweight to apply additional force on the device 20 during use, as described more fully below in connection with FIG. 2. The compression head 26 is removable from the body 22 and compressor 24 for cleaning, repair, or replacement. Ideally the compression head 26 has two ends 34, 36, with the first end 34 sized larger for use on adults and the second end 36 sized smaller for use on children, infants, or even animals. Coupling of the compression head 26 to the compressor 24 is accomplished via conventional connection devices that are readily commercially available. The compression head 26 can be equipped with a compression pad for bearing against the skin.

Control is effected by a simple trigger style switch 38, preferably built into the handle 32 and operable by the user's hand or fingers. Ideally the switch 38 is a variable speed control switch 38 that enables a responder to vary the number of compressions per minute administered by the compressor 24 to adapt the compression rate to the nature of the person or animal on which the device 20 is being used. In accordance with another aspect of the present disclosure, the device 20 can have a compressor 24 with an adjustable depth of compression or adjustable pressure applied by the compressor, again to accommodate the nature of the person or animal on which the device is used. This can be a manual adjustment, such as requires tools or a dial, or an electronic or other automatic variable adjustment via the switch 38, which would control depth instead of speed. The pressure of the compression head as it is applied to a person can also be controlled, either solely or in combination with either speed or depth, or both. Controlling pressure would accommodate the size of the person as well as those who are sensitive to pressure.

Use of the portable, hand-holdable device 20 is shown in FIG. 2 in which a responder 40 is holding the device 20 and applying it to an adult human 42. The larger end 34 of the compression head 26 is positioned over and pressed against the chest of the person 42. The responder activates the device 20 via the switch 38 and holds the device 20 in place with their hand 46 or hands. Speed, pressure, depth, or any combination of the foregoing of the compressions administered by the device 20 can be controlled via the switch 38 or other means as described above.

In accordance with a further aspect of the present disclosure, the device 20 can be equipped with an electronic sensor system 48 that includes an electrode 50 for attachment to the chest 44 and is either hardwired or wirelessly coupled to a sensor controller 52 that is coupled to the compressor 24. The sensor system 48 detects the presence of a pulse or the heart rhythm and shuts off the compressor 24, either directly or by deactivating the switch 38.

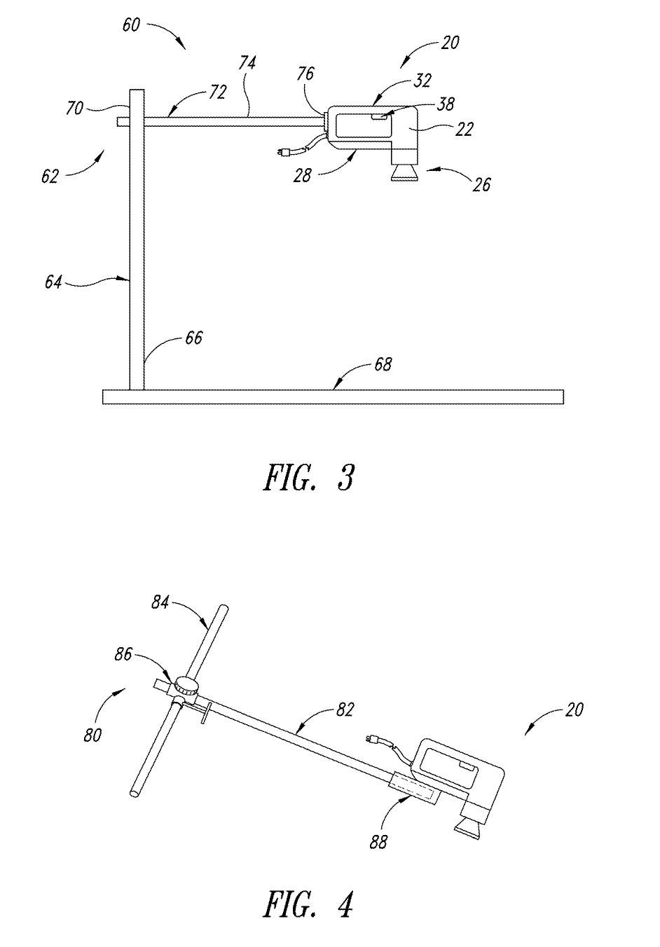

FIG. 3 illustrates a hands-free stand-alone floor-mount system 60 that includes a stand 62 coupled to the device 20. The stand 62 includes a vertical support 64 having a first end 66 attached to a horizontal foot 68 that holds the vertical support 64 upright. The vertical support 64 has a second end 70 to which is attached an arm 72 having a distal end 74. A mounting plate 76 is affixed to the distal end 74 of the arm 72 and is structured to hold the device 20 in releasable engagement. The stand 62 is sized and shaped to be used adjacent a bed, stretcher, or other supporting surface so as to hold the device 20 over the chest of the person.

To facilitate positioning of the device 20, one or all of the components of the stand 62 can be adjusted in its position relative to the other component to which it is attached. For example, the arm 72 can be slidably mounted to the vertical support 64 to slide horizontally as well as rotate horizontally and about a longitudinal axis. In addition, the arm 72 can slide or move vertically on the vertical support 64 to adjust the height of the device 20. Alternatively the arm 72 can be telescopically adjustable in its length as can be the vertical support 64. The means of connection between the stand components is done in a conventional manner using commercially available components.

In this implementation of the floor-mount system 60, the device 20 is attached to the mounting plate 76 at a rear of the body 22 of the device 20. However, it is to be understood that the device 20 can be attached to the arm 72 with other connection means that allows the device 20 to slide and rotate relative to the arm 72.

For example, as shown in FIG. 4 a rail mount system 80 is provided in which the device 20 is coupled to an arm 82 that is movably attached to a horizontal rail 84, such as a bed rail, gurney rail, etc. A connector 86 attaches the arm 82 to the horizontal rail 84 to enable the arm 82 to slide longitudinally and laterally as well as rotate relative to the rail 84. Other connectors can be employed that permit the arm to swing or pivot horizontally about a vertical axis if desired. Similarly, a connector 88 is utilized to attach the device 20 to the arm 82, which can be configured to enable the device 20 to rotate around a longitudinal axis of the arm 82, or slide along the longitudinal axis of the arm 82, or both. Other connectors may be used, such as a ball-and-joint connector to permit more universal movement of the device 20.

Other changes can be made, such as using articulating arms and vertical supports to provide more flexibility in the positioning of the device 20.

In accordance with a further aspect of the present disclosure, a portable, hand-holdable mechanical compression system for use in resuscitation is provided. The system includes a compression apparatus having a housing, a prime mover, and a compression head operatively coupled to the prime mover and configured for oscillatory movement in response to activation of the prime mover, the compression head having a compression pad sized and shaped to bear against skin, and a stand having a mounting apparatus and removably coupleable to the compression apparatus to support the compression apparatus for hands-free operation.

In accordance with another aspect of the foregoing implementation, the compression apparatus includes a handle for manual operation.

In accordance with a further aspect of the foregoing implementation, the compression apparatus is adjustable for one or more or all of a speed of oscillatory movement, a length of stroke of the compression head, and a pressure applied by the compression head during oscillatory movement of the compression head.

In accordance with another aspect of the present disclosure, the system includes a sensor coupled to the prime mover and configured to control activation and deactivation of the prime mover in response to the sensor sensing a heartbeat.

These and other changes can be made to the implementations in light of the above-detailed description. In general, in the following claims, the terms used should not be construed to limit the claims to the specific implementations disclosed in the specification and the claims, but should be construed to include all possible implementations along with the full scope of equivalents to which such claims are entitled. Accordingly, the claims are not limited by the disclosure.

1. A portable, hand-holdable mechanical chest compression device, comprising a compressor pad, and a prime mover to drive the compressor pad in an oscillating motion.

2. The device of claim 1, further comprising a handle and actuator control to render the device hand-holdable and the prime mover selectively controllable.

3. A mechanical chest compression system, comprising:
a portable chest compression device; and
a stand to support the device on the floor, ground, or other supporting structure.

4. The system of claim 3 wherein the portable chest compression device includes a compression head with a chest pad, and a prime mover to drive the compression head in a reciprocating motion.

5. The system of claim 3, comprising a back plate that attaches to the stand and opposes the force exerted by the portable chest compression device.

6. The system of claim 3, further comprising a sensor to detect the presence of a heartbeat and automatically shut off the chest compression device in response to the detection of the heartbeat.

7. The system of claim 4 wherein the compression head includes two ends, one sized for an adult human and the other sized for an human infant or child.

8. The system of claim 3 wherein the chest compression device is adjustable in either an amount of force or pressure, or in the depth of compression, or both.

9. A portable, hand-holdable mechanical compression system for use in resuscitation, comprising:
a compression apparatus having a housing, a prime mover, and a compression head operatively coupled to the prime mover and configured for oscillatory movement in response to activation of the prime mover, the compression head having a compression pad sized and shaped to bear against skin; and
a stand having a mounting apparatus and removably coupleable to the compression apparatus to support the compression apparatus for hands-free operation.

10. The system of claim 9 wherein the compression apparatus includes a handle for manual operation.

11. The system of claim 9 wherein the compression apparatus is adjustable for speed of oscillatory movement, length of stroke of the compression head, and pressure applied by the compression head during oscillatory movement of the compression head.

12. The system of claim 9, further comprising a sensor coupled to the prime mover and configured to control activation and deactivation of the prime mover in response to the sensor sensing a heartbeat.
